(19) United States
(12) Patent Application Publication
(10) Pub. No.: US 2010/0132916 A1
(43) Pub. Date: Jun. 3, 2010

(54) Supplemental Transport Heater for Tanker Trailers

(75) Inventor: Norman M. Stauffer, New Holland, PA (US)

Correspondence Address: MILLER LAW GROUP, PLLC, 25 STEVENS AVENUE, WEST LAWN, PA, 19609, US

(73) Assignee: Clean Burn, Inc.

(21) Appl. No.: 12/347,921

(22) Filed: Dec. 31, 2008

Related U.S. Application Data
(60) Provisional application No. 61/118,507, filed on Nov. 28, 2008.

(51) Int. Cl. B60H 1/00; F28D 15/00; G05D 23/00

(52) U.S. Cl. 165/41; 165/104.31; 165/270; 700/299

(57) ABSTRACT

A supplemental heating apparatus for use in conjunction with the coolant system of a truck engine provides a supplemental source of heat energy to the heat exchanger within a tanker trailer. The supplemental heating apparatus is activated when the truck engine is shut-off. A control system undertakes a testing cycle in which a circulator pulls coolant out of the tanker trailer and the temperature of the coolant is sensed after a delay of time so that the coolant from within the heat exchanger is tested. The burner draws fuel from the truck's fuel tanks to provide heat energy when the sensed temperature is below a threshold. The coolant is circulated between the boiler associated with the burner and the heat exchanger until the return coolant is raised above a second threshold. The testing cycle continues through a loop of a predetermined duration independent of the activation of the heating cycle.

### CROSS-REFERENCE TO RELATED APPLICATIONS

This application claims domestic priority on U.S. Provisional Application Ser. No. 61/118,507, filed on Nov. 28, 2008, and entitled “Transport Heater for Tanker Trailers”, the content of which is incorporated herein by reference.

### FIELD OF THE INVENTION

This invention is directed generally to the heating of materials transported in liquid form in tanker trailers, and particularly, to a heating apparatus that is operable to provide supplemental heat to the liquid material within the tanker trailer to maintain the temperature of the material within a preferred range.

### BACKGROUND OF THE INVENTION

Transporting certain materials, such as chocolate, require that the material be maintained in a liquid form so that the material can be discharged from the tanker for delivery thereof. Presently, the liquid material is maintained within the desired temperature range by coupling a heat exchanger within the tanker to the engine coolant system of truck pulling the tanker trailer. Heat is then diverted from the engine into the heat exchanger to maintain the desired temperature.

Regulations require long distance truckers to rest for prescribed periods during which the truck engine is continued to run so that the heating of the liquid material within the tanker trailer can be maintained. Such continued operation of the truck engine while the truck is not moving along the highway is expensive and wasteful in terms of fuel expended and extended maintenance of the engine, and is environmentally unfriendly. Furthermore, some governmental entities, including municipalities, counties and states, are adopting legislation that will limit the length of time that a truck can be idled while the operator is resting. While such legislation is intended to reduce vehicle emissions, the engine can no longer generate heat to maintain the temperature of the temperature-sensitive food products.

Accordingly, it would be desirable to provide a heating apparatus that can be utilized to provide supplemental heat to the tanker trailer while the truck engine is shut down. It would also be desirable to provide a heating apparatus that will be operable to maintain the desired temperature of temperature-sensitive food products or other liquid materials in a manner that is less costly than continuing the idled operation of the truck engine while the truck is not being moved along the highway.

### SUMMARY OF THE INVENTION

It is an object of this invention to overcome the disadvantages of the prior art by providing a supplemental heating apparatus to supply heat energy to a heat exchanger within a tanker trailer when the heat exchanger is not capable of obtaining heat energy from the truck.

It is another object of this invention to provide a supplemental heating apparatus that is selectively operable to provide heat energy to a heat exchanger in a tanker trailer to maintain the desired temperature of material carried within the tanker trailer.

It is a feature of this invention that the supplemental heating apparatus can be activated when the truck engine is turned off and can no longer provide a source of heat energy for the tanker trailer.

It is an advantage of this invention that the operation of the supplemental heating apparatus is substantially less expensive and more environmentally friendly than continuing the operation of the truck engine to supply heat energy for the tanker trailer while the truck and tanker trailer are not being moved across the highway.

It is another feature of this invention that the control system for the supplemental heating apparatus periodically samples the coolant circulated from the heat exchanger to determine if the material within the tanker trailer has cooled to a predetermined temperature.

It is still another feature of this invention that the control system will activate a heating cycle when the control system senses a temperature in said coolant below the predetermined temperature.

It is another advantage of this invention that the control system utilizes a predetermined delay before sensing the temperature of the coolant being circulated by the supplemental heating apparatus.

It is still another object of this invention to provide a supplemental heating apparatus that utilizes the fuel and electrical energy from supplies thereof carried by said truck.

It is yet another object of this invention to provide a supplemental heating apparatus that would be operable to provide a source of heating energy while the truck is circulating heated coolant to the heat exchanger within the tanker trailer.

It is still another feature of this invention that the control system goes through a test cycle irrespective of whether the burner assembly is being operated to provide heat energy to be transferred to the heat exchanger.

It is yet another feature of this invention that the control system activates a heating cycle when the temperature of the material in the tanker trailer drops below a predetermined threshold.

It is still another advantage of this invention that the test cycle continues to operate on its predetermined frequency even when the heating cycle has been activated.

It is yet another advantage of this invention that the test cycle incorporates a predetermined delay in checking the temperature of the coolant being circulated into the supplemental heating apparatus to obtain a reading of the temperature of the material within the tanker trailer.

It is a further object of this invention to provide a supplemental heating apparatus, and a method of operating the supplemental heating apparatus, to provide heat energy to a the contents of a tanker trailer, which is durable in construction, inexpensive of manufacture, carefree of maintenance, facile in assemblage, and simple and effective in use.

These and other objects, features and advantages are accomplished according to the instant invention by providing a supplemental heating apparatus for use in conjunction with the coolant system of a truck engine to provide a supplemental source of heat energy to the heat exchanger within a tanker trailer. The supplemental heating apparatus is activated when the truck engine is shut-off. The control system undertakes a testing cycle in which a circulator pulls coolant out of the tanker trailer and the temperature of the coolant is sensed after a delay of time so that the coolant from within the heat exchanger is tested. The burner draws fuel from the truck's fuel tanks to provide heat energy when the sensed temperature is below a threshold. The coolant is circulated between the boiler associated with the burner and the heat exchanger until the return coolant is raised above a second threshold. The testing cycle continues through a loop of a predetermined duration independent of the activation of the heating cycle.

### BRIEF DESCRIPTION OF THE DRAWINGS

The advantages of this invention will become apparent upon consideration of the following detailed disclosure of the invention, especially when taken in conjunction with the accompanying drawings wherein:

FIG. 1 is a side elevational view of a truck and tanker trailer having a supplemental heating apparatus incorporating the principles of the instant invention;

FIG. 2 is an enlarged partial side elevational view of the truck and tanker trailer of FIG. 1, showing the transport heater apparatus incorporating the principles of the instant invention;

FIG. 3 is a perspective view of the housing shell protecting the heating apparatus from the environment;

FIG. 4 is a rear perspective view of the transport heating apparatus and control assembly incorporating the principles of the instant invention;

FIG. 5 is a front perspective view of the transport heating apparatus and control assembly;

FIG. 6A is a logic flow diagram for the testing loop portion of the operating controls of the transport heating apparatus; and

FIG. 6B is a logic flow diagram for the heating loop portion of the operating controls of the transport heating apparatus, the combination of FIGS. 6A and 6B depicting the operating logic for the transport heating apparatus.

### DETAILED DESCRIPTION OF THE PREFERRED EMBODIMENT

Referring to the drawings, a transport heating apparatus incorporating the principles of the instant invention can best be seen. The truck 10 is conventionally operable to pull a tanker trailer 15 that is filled with a temperature-sensitive material, such as chocolate. The conventional heating system for the tanker trailer 15 utilizes a heat exchanger 16 within the tanker trailer 15 that is coupled in flow communication with the coolant system for the engine 12 via conduits 18, 19 that circulate engine coolant from the engine 12 to the heat exchanger 16 and return to the engine 12 while the engine 12 is operating. A valve (not shown) is operable to circulate the engine coolant when the temperature of the material within the tanker trailer 15 drops below a predefined threshold, or in a manual configuration when the operator feels additional heat is needed in the tanker trailer.

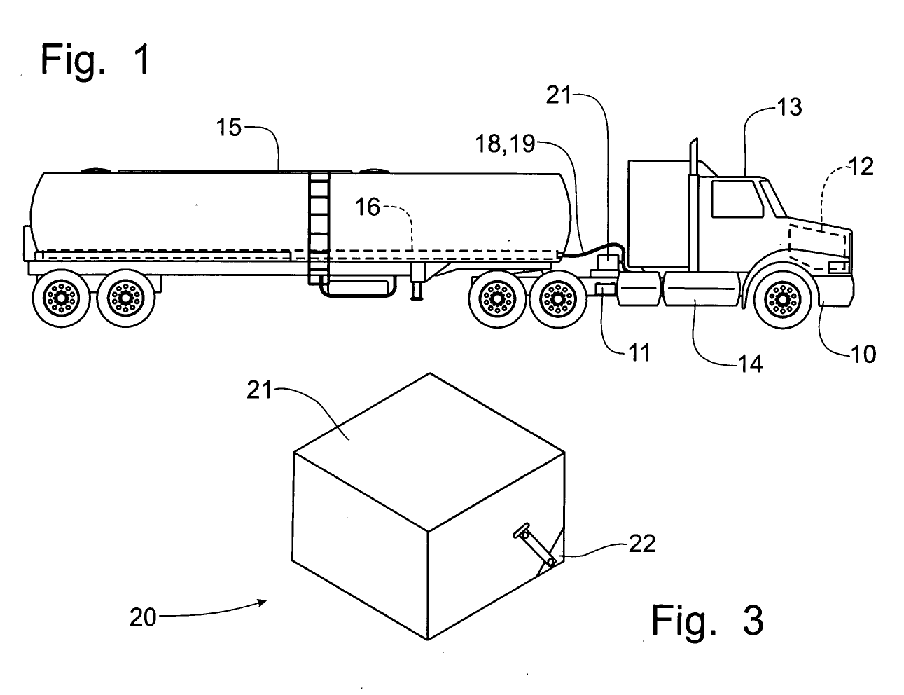

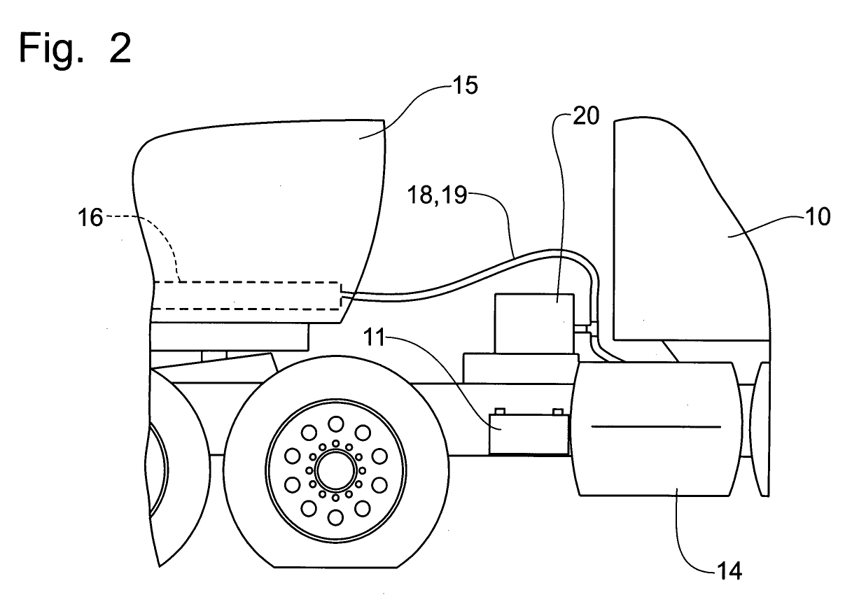

As best seen in FIGS. 1 and 2, the transport heating apparatus 20 is mounted on a truck 10 or on a tanker trailer 15 and is connected to the engine 12 of the truck 10 to supplement the conventional heating operation provided to the tanker trailer 15. Specifically, the transport heating apparatus 20 is tapped into the conduits 18, 19 that transfer engine coolant to and from the heat exchanger 16 within the tanker trailer 15. The primary purpose of the transport heating apparatus 20 is to provide heat to maintain the desired temperature of the temperature-sensitive material within the tanker trailer 15 while the engine 12 is not operating. Alternatively, the transport heating apparatus 20 can supplement the supply of heat to the heat exchanger 16 while the truck is being operated. In some cold climates, the heat requirements to maintain the desired temperature of the material within the tanker trailer 15 is sufficiently high that the operator's cab 13 cannot obtain sufficient heat from the coolant to maintain a comfortable operating environment within the operator's cab 13. In such cases, the supplemental heat provided by the transport heating apparatus 20 will facilitate the maintenance of a comfortable environment within the operator's cab 13.

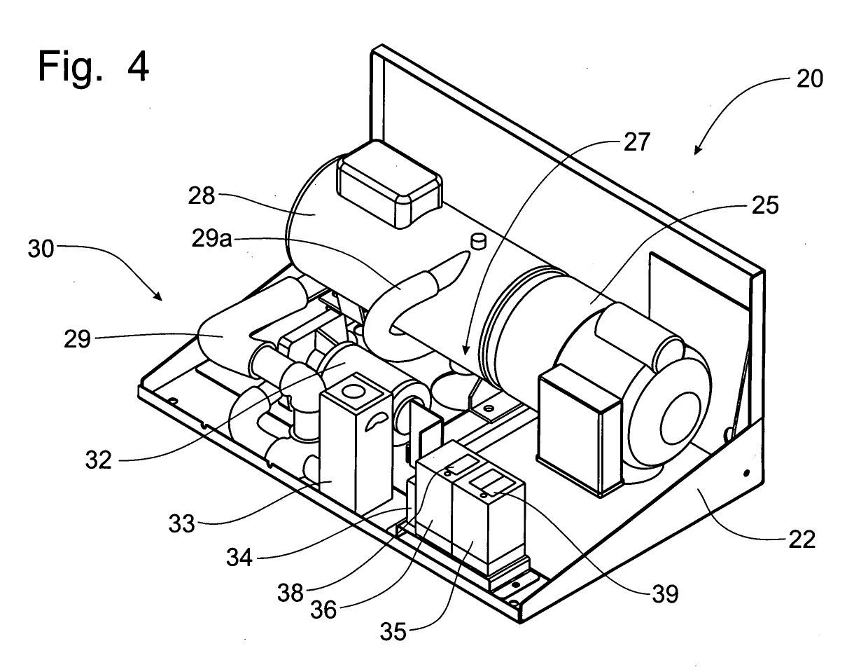

The components of the transport heating apparatus 20 are best seen in FIGS. 3-5. To protect the transport heating apparatus 20 from the environment while being transported on the truck 10 or trailer 15, a housing shell 21 is provided to cover the heating apparatus 20. The housing shell 21 is detachably connected to and, preferably, sealed against the base member 22 supporting most of the remaining components of the transport heating apparatus 20. On the base member 22 is mounted a conventional burner 25 that is operable to ignite and burn #2 diesel fuel, which is carried by the truck 10 to provide fuel for the operation of the engine 12. Accordingly, the transport heat apparatus 20 has a fuel line 26 that is coupled in flow communication to the fuel tanks 14 of the truck 10 to be able to draw fuel therefrom into the burner 25 to create heat energy. The burner 25 is also provided with an exhaust line 27 that is operable to discharge combustion gases from the burner 25 to the atmosphere when the burner 25 is operating to create heat energy.

The burner 25 has a boiler 28 that is connected to a coolant supply line 29 and a coolant return line 29a that is coupled in flow communication with the conduits 18, 19, respectively, to draw engine coolant from the coolant return conduit 19 via the coolant supply line 29 into the boiler 28 to be heated and then returned to the coolant supply conduit 18 for delivery to the heat exchanger 16 in the tanker trailer 15. In this manner, the heat energy created by the transport heating apparatus 20 can be used to supplement the heat provided by the operating engine, or to maintain the desired temperature of the material in the trailer while the engine 12 is not operating.

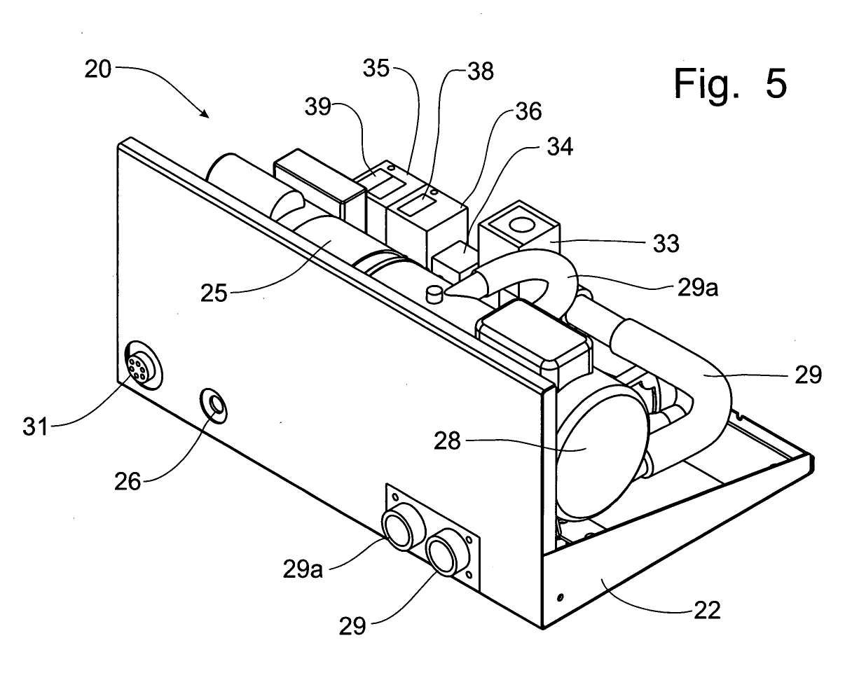

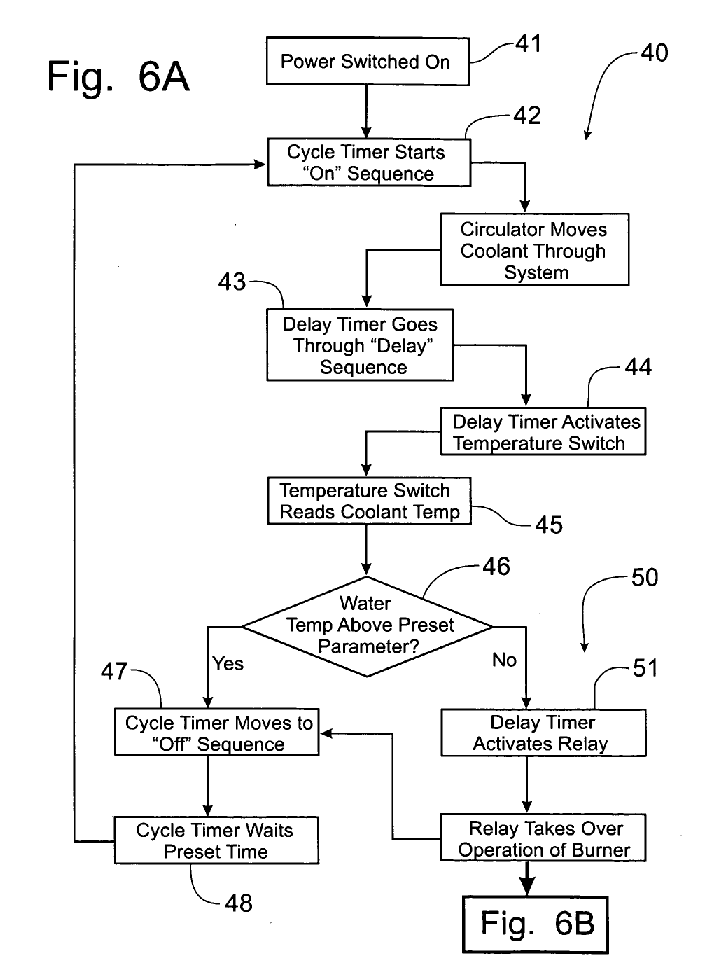

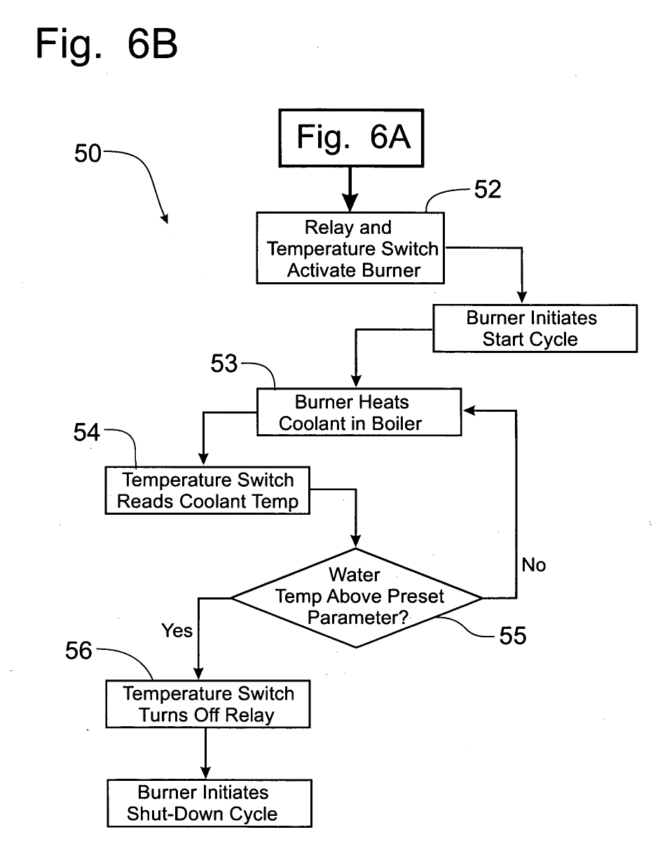

The controls for the operation of the transport heating apparatus 20 are shown in FIGS. 4 and 5, and explained in the logic flow diagram of FIG. 6. The control mechanism 30 is powered through an electrical connection 31 with the electrical system of the truck 10, which includes a battery 11, which can be a separate battery provided for the operation of the control mechanism 30, rather than utilize the electrical energy stored by the battery used for the starting of the truck 10. By providing a separate battery 11 for the operation of the transport heating apparatus 20, the draw of electrical current for the operation of the transport heating apparatus 20 will not endanger the starting of the engine 12. Preferably, the battery charging system of the engine 12 will be coupled to the battery 11 to recharge the battery 11 when the engine 12 is operating.

The control mechanism 30 includes a circulator 32 that is electrically powered and operable to circulate engine coolant from the coolant return conduit 19 through the coolant supply line 29 into the boiler 28 to be heated by the heat energy created from the burning of fuel therein, and returned to the coolant supply conduit 18 via the coolant return line 29a. The control mechanism also includes a temperature switch 33, a relay 34 a cycle timer 35 and a delay timer 36, all coupled electrically to the circulator 32 and to the burner 25 to control the operation thereof, as is described in greater detail below and shown in the logic flow diagram of FIG. 6. Preferably, the control mechanism 30 also includes an on/off switch (not shown) accessible by the operator within the operator's cab 13 when the operation of the transport heating apparatus 20 is desired, such as when the operator is about to shut down the engine 12 for an extended period of time, or when the operator is not getting sufficient heat from the heating system within the operator's cab 13.

As shown in FIG. 6, when the operator turns on the control system 30 at step 41, the cycle timer 35 starts it sequence at step 42. The circulator 32 begins to draw coolant from the coolant return conduit 19 into the boiler 28 and back out through the coolant return line 29a to the coolant supply conduit 18. This movement of the coolant by the circulator 32 brings coolant from the heat exchanger 16 through the transport heating apparatus 20 and back to the heat exchanger 16. Since the truck engine 12 is not being operated, there is no circulation of coolant from the engine 12 through the heat exchanger 16 and the circulator 32 creates a circuit that extends between the transport heating apparatus 20 and the heat exchanger 16.

As noted in step 43, the delay timer 36 runs through its cycle while the circulator 32 moves coolant from the heat exchanger 16 through the transport heating apparatus 20. Since there is no heat energy being supplied by the engine 12 to the heat exchanger 16, the liquid material within the tanker trailer 15 acts as a heat sink that equalizes the temperature of the coolant within the heat exchanger 16 with the temperature of the liquid material within the tanker 15. The operation of the delay timer 36 allows this coolant that was inside the tanker 15 to reach the transport heating apparatus 20, as compared to the coolant that was within the coolant return conduit 19 which was exposed to the environment outside of the tanker trailer 15 and would, therefore, likely have a cooler temperature than the coolant from within the heat exchanger 16, particularly if the ambient temperature is significantly cold.

The length of the delay required by the delay timer 36 is programmable through dip switches 38 accessible at the top of the delay timer 36. Preferably, the length of the delay is about a minute, but in practice depends on the circulation rate of the circulator 32 and the volume of coolant between the heat exchanger 16 and the transport heating apparatus 20. The operation of the delay timer 36 is to allow sufficient time for coolant from within the heat exchanger 16 to reach the transport heating apparatus 20. At step 44, the delay timer 36 reaches the end of the delay cycle and activates the temperature switch 33 at step 45 to ascertain the temperature of the coolant that is now passing through the transport heating apparatus 20.

At step 46, the temperature switch 33 compares the sensed temperature of the coolant with a present temperature parameter. If the sensed temperature is above the preset temperature parameter, then the cycle timer 35 turns off the circulator 32 at step 47 for a period of time determined by the settings of dip switches 39 accessible at the cycle timer 35 to adjust the timing of the cycle. The cycle timer 35 then cycles through the pre-established period of time at step 48 before starting the “on” sequence again at step 42. The operation of the cycle timer 35 shuts down the circulator which has a substantial draw of electrical current from the battery 11. Therefore, the cycle timer 35 saves electrical energy for use by the control mechanism 30 when the application of heat energy to the liquid material within the tanker 15 is required.

The circulation of the coolant from the heat exchanger 16 into the transport heating apparatus 20 draws colder coolant from the coolant supply line 18 into the heat exchanger 16. However, the heat sink that is the liquid material is sufficient to warm the new coolant to the same temperature as the liquid material within the tanker 15 during the period of time corresponding to the “off” sequence of the cycle timer 35. Eventually, the period established by the cycle timer 35 expires and the cycle timer 35 goes into the “on” cycle at step 42 and once again activates the circulator 32 to bring coolant from the heat exchanger 16 into the transport heating apparatus 20. The delay timer 36 allows the temperature switch 33 to delay sensing the temperature of the coolant when sufficient time has expired to allow the coolant from within the heat exchanger 16 to reach the temperature switch 33.

Again, the temperature switch 33 compares the sensed temperature with the preset temperature parameter at step 46 and moves the cycle timer 35 to the “off” sequence at step 47 if the sensed temperature is above the preset temperature parameter. The cycle continues through this testing loop 40 established by the cycle timer 35 until the temperature of the coolant passing through the temperature switch 33 drops below the preset temperature parameter at step 46 and the controls pass into the heating loop 50.

At step 51, the delay timer 35 activates the operating relay 34 which assumes control of the power through the transport heating apparatus 20 and allows the cycle timer 35 to move into the “off” sequence at step 47. At step 52, the operating relay 34 and the temperature switch 33 activate the burner 25, which then goes through the start cycle and fires heat energy into the boiler 28 at step 53. Meanwhile, the circulator 32 continues to circulate coolant between the heat exchanger 16 and the transport heating apparatus 20. The temperature switch 33 reads the temperature of the coolant coming into the transport heating apparatus 20 through the coolant supply line 29 at step 54 before being heated from the boiler 28 and decides at step 55 whether the temperature of the coolant, and therefore, the approximate temperature of the liquid material in the tanker 15 is above or below a pre-established temperature parameter, which is preferably at a higher level than the first temperature parameter used at step 46, though could be the same temperature parameter.

If the sensed temperature is above the preset temperature parameter, the temperature switch 33 turns off the operating relay 34 at step 56, causing the burner 25 to go through its shut-down cycle and stop producing heat energy. On the other hand, if the sensed temperature is still lower than the preset temperature parameter at step 55, the burner 25 is allowed to continue operating, transferring heat energy to the coolant in the boiler 28 which is circulated to the heat exchanger 16 to continue to warm the liquid material within the tanker trailer 15. As long as the heating cycle 50 continues, the operation of the transport heating apparatus 20 is within the control of the relay 34; however, the cycle timer 35 continues to operate through its preset cycle. When the cycle timer 35 initiates the “on” sequence at step 42, the circulator 32 is already operating and the relay 34 is already activated and the operation of the cycle timer 35 is of no consequence. Nevertheless, the cycle timer 35 continues through the testing loop 40 so long as electrical power is being supplied to the control mechanism 30 at step 41.

When the sensed temperature is greater than the preset temperature parameter at step 55 and the burner 25 shuts down, the control of the transport heating apparatus 20 is returned to the cycle timer 35 within the testing loop 40. Assuming that the heating loop 50 shuts down when the cycle timer 35 is in mid-cycle, the “on” sequence at step 41 is undertaken in less time than a complete predetermined period for the cycle timer 35, but the temperature of the coolant sensed at step 45 should substantially always be greater than the first preset temperature parameter and the cycle timer 35 will go through a complete cycle through the testing loop 40.

One skilled in the art will note that the transport heating apparatus 20 obtains fuel from the truck's fuel tanks 14 through the fuel line 26 and receives electrical power from the battery 11 carried by the truck 10 through the electrical connector 31. Thus, the transport heating apparatus 20 is operable from the power and fuel supplies of the truck 10 even when the engine 12 of the truck 10 is shut down. Such an operation is beneficial in reducing vehicle emissions since the liquid material within the tanker trailer 15 can be kept at a desired temperature without requiring the engine 12 to be running. Furthermore, since the engine 12 is not running continuously to provide heat to maintain the temperature of the temperature-sensitive material, the desired temperature can be maintained with only about one-third of the fuel the truck 10 would have expended while continuously operating just to maintain the desired temperature.

By turning on the power switch for the transport heating apparatus 20 while the truck 10 and tanker trailer 15 are moving along the highway, the transport heating apparatus 20 can be used to supplement the heat energy provided by the operation of the truck engine 12. This supplemental operation of the transport heating apparatus 20 is particularly useful when temperature-sensitive food materials are being shipped by tanker truck 10 during really cold ambient temperatures. In such an operation, the engine heat is being transferred via normal operation of the coolant supply and return conduits 18, 19 interconnected the engine 12 and the heat exchanger 16, but the engine cannot generate sufficient amounts of heat to keep the temperature-sensitive materials within the desired temperature range.

Therefore, when the cycle timer 35 initiates the “on” sequence, as is noted above, at step 42, the sensed temperature at step 45 of the coolant coming from the heat exchanger 16 through the return conduit 19 will be below the desired preset temperature as determined at step 46. The relay 34 starts the circulator 32 running to draw the flow of coolant from the coolant return conduit 19 and returns the heated coolant back to the coolant supply conduit 18, short-circuiting the primary heating loop between the heat exchanger 16 and the engine 12.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention.

Having thus described the invention, what is claimed is:

1. A supplemental heating apparatus for tanker trailer having a heat exchanger within the tanker trailer, said heat exchanger having coolant flowable therethrough to carry heat energy into said tanker trailer, comprising:
a housing;
a burner mounted on said housing and being connected to a supply of fuel;
a boiler in flow communication with said heat exchanger to direct a flow of coolant therethrough, said boiler being operable to transfer heat energy created by said burner to said coolant;
a circulator to move coolant from said heat exchanger through said boiler; and
a control apparatus to control the operation of said burner and said circulator.

2. The supplemental heating apparatus of claim 1 wherein said tanker trailer is connectable to a truck carrying said supply of fuel, said supplemental heating apparatus being mounted on said truck.

3. The supplemental heating apparatus of claim 2 wherein said control apparatus is powered electrically from a battery carried by said truck.

4. The supplemental heating apparatus of claim 1 wherein said control apparatus includes a testing circuit and a heating circuit, said testing circuit determining if operation of said heating circuit is needed, said heating circuit providing operation of said burner to create heat energy.

5. The supplemental heating apparatus of claim 4 wherein said testing circuit comprises:
a temperature sensor operable to detect the temperature of said coolant flowing into said boiler;
a delay cycle timer operably connected to said circulator and to said temperature sensor to conduct a test cycle during which said delay cycle timer initiates operation of said circulator to cause coolant to flow from said heat exchanger into said boiler, said delay cycle timer affecting a detection of the temperature of said coolant by said temperature sensor after a predetermined delay following initiation of operation of said circulator.

6. The supplemental heating apparatus of claim 5 wherein said predetermined delay is established to provide sufficient time for coolant to be transferred from said heat exchanger to said temperature sensor.

7. The supplemental heating apparatus of claim 5 wherein said delay cycle timer activates a relay to control operation of said burner when the temperature of said coolant detected by said temperature sensor is below a first predetermined threshold, said circulator moving coolant between said boiler and said heat exchanger until the temperature of said coolant detected by said temperature sensor is above a second predetermined threshold.

8. The supplemental heating apparatus of claim 5 wherein said delay cycle timer is operable to deactivate said circulator if the temperature detected by said temperature sensor is above said first predetermined threshold, said delay cycle timer being operable to conduct subsequent said test cycles after passage of a predetermined period of time between said test cycles.

9. The supplemental heating apparatus of claim 8 wherein said delay cycle timer includes:
a cycle timer having an adjustable timer to permit a variation of said predetermined period of time between said test cycles; and
a delay timer having an adjustable timer to permit a variation of said predetermined delay between initiation of said circulator and detection of the temperature of said coolant by said temperature sensor.

10. A method of heating material within a tanker trailer having a heat exchanger including conduits extending therefrom with coolant therein, comprising the steps of:
coupling a supplemental heating apparatus having a burner assembly, a circulator and a control apparatus, to said conduits to form a circuit wherein coolant can be circulated between said heat exchanger and said burner assembly by said circulator;
activating a test cycle including repeated testing sequences separated by inactive periods lasting for a predetermined period of time, each testing sequence including the steps of:
initiating the operation of the circulator to move coolant from said heat exchanger to said burner assembly; and
sensing the temperature of said coolant after a predetermined delay following the initiating step;
initiating a heating cycle when said sensing step senses a coolant temperature lower than a first predetermined threshold, said heating cycle including the steps of:
operating said burner assembly to generate heat energy;
circulating coolant between said burner assembly and said heat exchanger to transfer heat energy to said material in said tanker trailer;
detecting the temperature of said coolant before flowing into said burner assembly;
halting said heating cycle when said detecting step detects a coolant temperature higher than a second predetermined threshold.

11. The method of claim 10 wherein said initiating step further includes the step of:
moving the test cycle to the inactive sequence.

12. The method of claim 11 wherein said test cycle continues through periodic testing sequences independently of said heating cycle.

13. The method of claim 12 wherein said control apparatus includes a cycle timer defining said predetermined period of time of said inactive periods in said test cycles.

14. The method of claim 13 wherein said control system includes a delay timer defining said predetermined delay in said sensing step after said initiating step.

15. The method of claim 14 wherein said cycle timer and said delay timer are adjustable to vary the respective periods of time defined thereby.

16. The method of claim 15 wherein said burner assembly includes a burner that creates heat energy by burning fuel and a boiler that transfers heat energy to said coolant, said coolant being circulated through said boiler, said sensing and detecting steps occurring before coolant enters said boiler.

17. A method of controlling the operation of a supplemental heating apparatus coupled to a heat exchanger in a trailer connectable to an engine cooling system to transfer heat energy generated from said engine to said heat exchanger, comprising the steps of:
supplying electrical power to control apparatus in said supplemental heating apparatus;
activating a test cycle including repeated testing sequences separated by inactive periods lasting for a predetermined period of time, each testing sequence including the steps of:
initiating the operation of a circulator in said supplemental heating apparatus to move coolant from said heat exchanger to a burner assembly; and
sensing the temperature of said coolant after a predetermined delay following the initiating step; and
operating a heating cycle when said sensing step senses a coolant temperature lower than a first predetermined threshold until said coolant reaches a predetermined second predetermined threshold.

18. The method of claim 17 wherein said supplying step occurs when said engine is not operating to provide a source of heat energy for said heat exchanger.

19. The method of claim 17 wherein said heating cycle includes the steps of:
firing said burner assembly to generate heat energy;
circulating coolant between said burner assembly and said heat exchanger to transfer heat energy to said trailer;
detecting the temperature of said coolant before flowing into said burner assembly;
terminating said heating cycle when said detecting step detects a coolant temperature higher than a second predetermined threshold.

20. The method of claim 17 wherein said operating step further includes the step of:
moving the test cycle to the inactive sequence, said test cycle continuing through periodic testing sequences separated by said predetermined period of time independently of said heating cycle.
